(19) United States
(12) Patent Application Publication
(10) Pub. No.: US 2019/0267181 A1
(43) Pub. Date: Aug. 29, 2019

(54) AN INDUCTIVE DEVICE AND A MANUFACTURING METHOD

(71) Applicant: Höganäs AB (Publ), Höganäs (SE)

(72) Inventor: Fredrik AF EKSTROM, Helsingborg (SE)

(73) Assignee: Höganäs AB (Publ), Höganäs (SE)

(21) Appl. No.: 16/345,585

(22) PCT Filed: Oct. 27, 2017
(86) PCT No.: PCT/EP2017/077596

§ 371 Date: Apr. 26, 2019

(30) Foreign Application Priority Data
Oct. 28, 2016 (EP) 16196311.1

(51) Int. Cl. H01F 27/29; H01F 27/28; H01F 27/24; H01F 41/02; H01F 41/076

(52) U.S. Cl. CPC H01F 27/29; H01F 27/2823; H01F 41/076; H01F 41/0206; H01F 27/24

(57) ABSTRACT

An inductive device and a manufacturing method. The inductive device including: a magnetic core forming a void and a void opening; a winding accommodated in the void of the magnetic core; at least one lead wire extending from the winding; a cured material provided at least at a part of the void opening; and at least one rigid terminal element connected to the winding via the at least one lead wire, the at least one rigid terminal element being partly embedded in and protruding from the cured material.

### TECHNICAL FIELD

The present disclosure relates to an inductive device and a method for manufacturing an inductive device.

### BACKGROUND

Examples of inductive devices include transformers and inductors, sometimes also referred to as reactors or chokes.

Inductors are used in a wide array of applications such as signal processing, noise filtering, power generation, electrical transmission systems etc. In order to provide more compact and more efficient inductors, the electrically conducting winding of the inductor may be arranged around an elongated magnetically conducting core, also referred to as magnetic core.

Inductive devices are available in a large variety of designs and materials, each having their specific advantages and disadvantages. However, in view of the ever increasing demand for inductive devices in different applications there is still a need for inductive devices having a flexible and efficient design and which are usable in a wide range of applications.

Magnetic cores for inductive devices may be manufactured by pressing a soft magnetic powder material, e.g., an iron powder. The powder may be put into a cavity wherein the powder may be compacted.

Magnetic cores for inductive devices may be manufactured in a variety of designs. One design of magnetic cores, sometimes referred to as a pot core design, the magnetic core includes a base core portion from which an outer core portion and an inner core portion extend, e.g., in an axial direction. The inner core portion and the outer core portion define a void between them for accommodating the winding where the winding is arranged around the inner core portion. Inductive devices of this type provide a high degree of shielding against electromagnetic fields which otherwise may affect other electrical components in the vicinity of the inductor.

It remains desirable to provide improved inductive devices that allow an efficient manufacturing and assembly.

### SUMMARY

It may be desirable to provide improved inductive devices that facilitate storage and/or handling and/or transportation and/or connection with other electrical parts.

Disclosed herein are embodiments of an inductive device comprising: a magnetic core forming a void and a void opening; a winding accommodated in the void of the magnetic core; at least one lead wire extending from the winding; a cured material provided at least at a part of the void opening; and at least one rigid terminal element connected to the winding via the at least one lead wire, the at least one rigid terminal element being partly embedded in and protruding from the cured material.

Provision of the above-mentioned inductive device and in particular provision of the rigid terminal element, may facilitate connection to any external electrical circuit or device and/or may facilitate the process of connecting the inductive device to an external electrical circuit or device. Having the rigid terminal element protruding from the cured material may enable and/or facilitate connection to an external electrical circuit/device. Having the rigid terminal element being partly embedded in the cured material may provide an improved compact inductive device, which may take up less space compared to an otherwise similar device but where the rigid terminal element is not embedded in the cured material. Having the rigid terminal element being partly embedded in the cured material may provide an improved fixation of the rigid terminal element in relation to the magnetic core and/or other parts of the inductive device being connected to the cured material. Accordingly, storage and/or handling and/or transportation of the inductive device may be facilitated.

Embodiments of the inductive device may provide a volume efficient inductive device in a cost-efficient and comparably simple manner.

The inductive device may be or comprise an inductor or a transformer or a similar device. An inductive device according to the present invention may throughout the present disclosure simply be denoted “inductor” or “inductive device”.

The winding typically comprises a plurality of turns. The turns define a central hole through which, during operation, the magnetic flux extends which is caused by electrical current through the turns of the winding. Thus, an axial direction may be defined by the turns of the winding as the direction of the magnetic flux through the center of the turns of the winding. The winding may be substantially cylindrical, although other geometries are possible as well.

The winding and the at least one lead wire (such as lead wires extending from both conductive ends of the winding) may be formed by a (such as one single) conductor (e.g., a wire, such as an at least partly isolated wire). Accordingly, part of a conductor may be formed into the winding with ends, i.e., lead wires, such as two lead wires, extending from the winding. Such conductor formed into a winding with extending lead wires may be isolated, e.g., by a coating of enamel or similar or another coating.

For the purpose of the present description the terms radial, axial, and circumferential are intended to refer to the respective directions of a cylindrical coordinate system defined relative to the axial direction defined by the winding, unless explicitly stated otherwise.

The void of the magnetic core may be defined as a volume, such as an at least partly enclosed volume, defined by the magnetic core and suitable for accommodating a winding.

The inductive device may comprise a plurality of windings. A second winding may be accommodated in the void of the magnetic core.

The magnetic core may form a plurality of void openings, such as the void opening and a second void opening. The second void opening may be arranged similar to the void opening, i.e., by having the cured material provided at least at a part of the second void opening; and having a second rigid terminal element (which is connected to the winding (or the second winding) via a second lead wire) being partly embedded in and protruding from the cured material.

Providing the cured material at least at a part of the void opening may be understood as the cured material not necessarily being within the void opening, but close to, such as within 1 mm, e.g., inside the void of the magnetic core.

The at least one rigid terminal element may comprise a plurality of rigid terminal elements, such as two rigid terminal elements, such as two rigid terminal elements for each winding.

The at least one rigid terminal element being connected to the winding via the at least one lead wire may cause that an electrical connection is established between the winding and the at least one rigid terminal element.

Throughout the present disclosure the term “void opening” may be understood as: “one or more void opening”. The void opening may be denoted “aperture”.

Throughout the present disclosure the term “rigid terminal element” may be understood as: “one or more rigid terminal element of the at least one rigid terminal element, such as a first rigid terminal element and/or a second rigid terminal element”.

Throughout the present disclosure the term “lead wire” may be understood as: “one or more lead wire of the at least one lead wire, such as a first lead wire and/or a second lead wire”.

In one or more embodiments the magnetic core is of the pot core type. Such core may provide a shielding effect, preventing or impeding radiation and reducing electromagnetic interference. A pot core may be provided by two halves, which may be identical, and which may fit together around the winding.

The magnetic core may comprise a base core portion from which an outer core portion and an inner core portion extend in the axial direction so as to form the void for accommodating the winding. A further base core portion may be provided at the opposite end of the inner and outer core portions. A base core portion may have a disc-like shape.

The void opening may be provided in the outer core portion.

In one or more embodiments, the inner core portion, the winding, and the outer core portion are arranged coaxially around the axial direction, with the inner core portion positioned radially most inward, successively surrounded by the winding, and the outer core portion.

The magnetic core may be formed by a plurality of core components such as at least two core components such as a first core component and a second core component. The first core component may comprise the base core portion and either: at least a part of the outer core portion or at least a part of the inner core portion or both. The second core component may comprise an end portion (e.g., the further base core portion) and complementary parts of the inner core portion and/or the outer core portion, such that the first and second core components, when assembled with each other, form the magnetic core. It will be appreciated that, in one or more embodiments, the first and second core components may be identical, thus forming two halves of the magnetic core while, in other embodiments, the first and second components may be different from each other. For example, in one or more embodiments, the first component may comprise the base core portion and the entire outer core portion and the entire inner core portion so as to form a receptacle for receiving the winding. In such an embodiment, the second core component may be formed as a lid for closing the open end of the first core component. In alternative embodiments, the first core component may comprise the base core portion and the entire outer core portion while the second core component comprises an end portion (e.g., a further base core portion) and the entire inner core portion. In yet another embodiment, the first core component may comprise the base core portion and the entire inner core portion while the second core component comprises an end portion (e.g., a further base core portion) and the entire outer core portion. It yet other embodiments the inner core portion and the outer core portion may be distributed between the first and second core components in a different manner. In one or more embodiments, one or more such as each magnetic core component forms a receptacle for receiving a part, e.g., one half, of the winding.

In one or more embodiments, the base core portion has an inner surface and an opposite, outer surface; wherein the inner core portion and the outer core portion axially extend from the inner surface. The outer core portion may at least partly surround the inner core portion, thereby forming the void around the inner core portion for accommodating the winding.

In one or more embodiments, the inner surface of the base core portion comprises a recess for accommodating at least a part of the lead wire. The recess may extend at least a part of a distance between the inner core portion and the outer core portion. The outer core portion may define the void opening, e.g., an aperture, which may be formed at least in part by a slit, extending from the end wall at the position of the recess. The outer core portion may be formed as a wall extending axially from the inner surface of the base core portion and having an end facing away from the inner surface. The aperture may be formed, at least in part, as a slit extending axially from said end to the inner surface. By virtue of the recess of the base core portion and the aperture, the lead wire of the winding may be conveniently arranged to extend through or to or close to the aperture and inside the recess without occupying any valuable winding space within the magnetic core. In one or more embodiments, the outer surface of the base core portion comprises an elevated area opposite to the recess. The elevated area opposite the recess may enable manufacture of a magnetic core including a recess and an aperture in a single pressing operation, i.e., without requiring any aftermachining (such as a separate milling process). Furthermore, this may be achieved using a comparably simple press, e.g., without requiring any additional independently controllable punch. The elevated area adds to the second surface (i.e., the outer surface of the base core potion) at least some of the volume which is occupied by the recess, i.e., lost in the base core portion in order to form the recess, and thereby makes formation of the base core portion possible by reducing any biasing of the punch which otherwise may be caused by the presence of the recess. Consequently, the magnetic core may be manufactured in a cost and time efficient manner using a relatively simple press. In one or more embodiments, the end portion of the magnetic core opposite the base core portion may likewise comprise one or more recesses on its inner surface and, optionally, one or more corresponding protrusions on its, outer surface as described in connection with the base core portion.

According to one or more embodiments, a recess extends to an outer edge of the inner surface of the base core portion.

According to one or more embodiments the aperture extends to the recess such that the aperture joins the recess wherein the recess forms a periphery of the aperture.

According to one or more embodiments, the dimension of the outer core portion in the axial direction away from the inner surface of the base core portion exceeds the dimension of the inner core portion in the axial direction away from the inner surface.

In one or more embodiments, the magnetic core comprises two magnetic core components, each comprising the base core portion, an inner core portion and an outer core portion; wherein a rim of the outer core portion of the first magnetic core component engages with a corresponding rim of the outer core portion of the second magnetic core component, and wherein the respective inner core portions of the first and second magnetic core components together form an elongated inner core portion defining a gap, sometimes known as an air gap. In some applications it may be desirable to use a magnetic core including an air gap since a properly arranged air gap inter alia may reduce the inductance sensitivity to current variations.

The magnetic core may be made from and/or comprise a soft-magnetic composite powder material, which may be compressed for providing the magnetic core or components thereof. The powder material may be a ferrite powder, a high purity iron powder, a Fe—Si powder, other silicon-alloyed powders, an iron-phosphorous alloy or some other powder material with similar properties. Optionally, the material may be a soft magnetic composite powder material including a soft magnetic powder (e.g., iron) provided with an electrically insulating coating. Examples of composite materials that may be used are Somaloy 110i, Somaloy 130i, Somaloy 500, Somaloy 700 and Somaloy 1000 which may be obtained from Höganäs AB, S-263 83, Höganäs, Sweden. According to one or more embodiments, the compressed soft magnetic powder material includes at least 80% by weight of iron, such as at least 90% by weight of iron, such as at least 95% by weight of iron. An increased percentage of iron may improve the compressibility of the powder.

The magnetic core may have an extension in the axial direction of at least 1.5 mm (such as at least 4 mm) and/or less than 20 mm (such as less than 15 mm).

The magnetic core may have an extension in a second direction, perpendicular to the axial direction, of at least 3 mm (such as at least 8 mm) and/or less than 50 mm (such as less than 30 mm).

The thickness of the outer portion of the magnetic core, such as at a rim defining the void opening, may be at least 0.5 mm, such as at least 1 mm.

The inductive device may comprise a coil former, such as a bobbin, around which the winding may be provided. The coil former may be accommodated in the void of the magnetic core. The coil former may comprise one or more walls together defining a void for receiving the winding and separating at least a part of the winding from at least part of the magnetic core.

The rigid terminal element may protrude from the void opening. This may facilitate storage and/or handling and/or transportation of the inductive device. For instance, if the rigid terminal element protrudes from the void opening provided in an outer surface of the inductive device having a relative smooth and rounded surface, the rigid terminal element may impede the inductive device from rolling. Rolling of the inductive device may be impeded by a protruding rigid terminal element of an inductive device having other outer surface structures. The rigid terminal element may protrude in a perpendicular direction relative to a plane and/or a surface defining and/or following the void opening. The rigid terminal element may protrude at least 0.5 mm such as at least 1 mm from the void opening.

The void opening may be understood as the area or volume defined within the edges of the outer core portion outlining the void opening. The void opening may be understood as an area or volume missing in the outer core portion, such as a tubular wall part, such as a wall part of the same thickness as the wall thickness of the outer core portion.

The rigid terminal element may be at least partly accommodated within the void opening. This may facilitate a volume-efficient solution, where the ratio of space within the void for the winding and the rigid terminal element is improved, i.e., by lowering the void space needs for the rigid terminal element. Additionally, or alternatively, this may facilitate that the rigid terminal does not protrude more than desired from the inductive device, e.g., such as less than 4 mm such as less than 2 mm.

The cured material may be provided within at least a part of the void opening. This may strengthen the mechanical coupling between the rigid terminal element and the magnetic core. The cured material may fill the void opening. This may further strengthen the mechanical coupling between the rigid terminal element and the magnetic core. The cured material may be provided within and/or fill the void (i.e., the parts of the void not occupied by another element, such as the winding, the at least one lead wire, etc.) and may be connected to the cured material at the void opening. This may strengthen the mechanical coupling between the rigid terminal element and the magnetic core. Furthermore, the stability of the winding with respect to the magnetic core may be strengthened.

The rigid terminal element may extend along a longitudinal direction defining a distal end of the rigid terminal element protruding from the cured material and a proximal section of the rigid terminal element embedded in the cured material. The structure of the outer surface of the proximal section may be defined during attachment of the rigid terminal element to the lead wire, e.g., by clamping the part of the rigid terminal element accommodating the lead wire.

An outer surface (e.g., an outer surface of a cross section taken perpendicular to the longitudinal direction) of the proximal section may be non-circular, such as polygonal, and/or may comprise one or more protrusions. This may facilitate rotational stability of the rigid terminal element with respect to the cured material and/or the rest of the inductive device. The outer surface of at least a part of the proximal section may be formed during attachment of the rigid terminal element to the lead wire.

The rigid terminal element may comprise an external connection part (e.g., located at the distal end of the rigid terminal element), such as a threaded external connection part, such as a threaded protrusion or a threaded hole such as a threaded bore. The external connection part may be configured to enable electrical connection, e.g., with an external part, such as an electrical device or circuit, e.g., via a respective wire. Connection to an external wire may be facilitated similar to the connection between the rigid terminal element and the lead wire.

The rigid terminal element may comprise an internal connection part (e.g., located opposite the distal end of the rigid terminal element) arranged for connection with the lead wire. The internal connection part may comprise an inner surface of the rigid terminal element defining a void such as a hole, e.g., a threaded hole, e.g., a threaded bore. Alternatively to being threaded, the inner surface may define one or more protrusions.

The threaded bore of the internal connection part and the threaded bore of the external connection part may form a threaded through hole which may extend along the longitudinal direction of the rigid terminal element. This may simplify the inductive device and may facilitate electrical connection to the lead wire and/or externally. Furthermore, production of the rigid terminal element may be simplified.

The rigid terminal element may comprise and/or be made of metal or a metal alloy, such as a metal alloy containing any one or combination of: {copper, zinc, and tin}. The rigid terminal element may comprise and/or be made of an electrically conductive material. The rigid terminal element may be defined as being more rigid than (such as at least twice as rigid as) a conductor or wire forming the lead wire and/or the winding.

The cured material may comprise or consist of any one or more of the following: {cured resin, cured epoxy, and cured polyurethane}. The cured material may be none magnetic conductive and/or none electric conductive. An advantage hereof (in particular of being none electric conductive) may be that the outer surface of the rigid terminal element (in particular of the part thereof embedded in the cured material) may be electrical conductive.

In one or more embodiments, the inductor device comprises a flow channel defining an inlet port for inserting a curable material into the flow channel. The flow channel may define an outlet port opening into the void of the magnetic core, e.g., at a location opposite the void opening. Accordingly, the curable material may be provided to at least a part of the inductor device, such as at least initially by filling the void of the magnetic core.

The inductive device may be provided with one or more holes or channels providing a fluid conduit providing the flow channel to the void, so as to allow the curable material inserted into the inlet port of the flow channel to enter said void.

The flow channel may provide a connection from the inlet port to the winding accommodated in the void of the magnetic core. The method may comprise providing the curable material via the inlet port of the flow channel. The curable material may be provided under pressure, e.g., via the inlet port.

The filling may comprise inserting, optionally under pressure, a curable material into the inlet port of a flow channel formed by the inductive device.

In one or more embodiments the method comprises inserting a liquid, curable material into the inlet port when the assembled combination of magnetic core and winding is placed with the void opening formed in the outer core portion of the magnetic core facing upwards. The method may thus comprise letting the liquid curable material to flow through the flow path so as to fill the void. Hence, any space inside the inductive device which is left unoccupied by the winding (or any other device, such as a coil former) may be filled by the curable material from below in an efficient manner avoiding inclusions of gas.

The liquid, curable material may enter the void from below, and the level of curable material inside the magnetic core may rise gradually during the filling process, so as to fill any space inside the void that is left unoccupied by the winding. When the curable material reaches a desired level, e.g., at the void opening—e.g., at the rim of the aperture, the filling process may be stopped and the curable material may be allowed to cure.

Hence, an efficient filling process of the space surrounding the winding is provided while the inductor may be kept compact and a reliable insulation between the winding and the magnetic core is provided.

According to one or more aspects of the present invention, the curable material may be provided at the void opening by entering via the void opening.

The present disclosure relates to different aspects including the inductive device described above and in the following and to corresponding methods and/or products. Each aspect may yield one or more of the benefits and advantages described in connection with one or more of the other aspects, and each aspect may have one or more embodiments with all or just some of the features corresponding to the embodiments described in connection with one or more of the other aspects and/or disclosed in the appended claims.

According to a further aspect there is provided a method for manufacturing an inductive device, such as according to the present disclosure, the method comprising: providing a magnetic core forming a void and a void opening; providing a winding in the void of the magnetic core; providing at least one lead wire extending from the winding; providing at least one rigid terminal element connected to the winding via the at least one lead wire; and providing a curable material at least at a part of the void opening, such that the at least one rigid terminal element being partly embedded in and protruding from the curable material. The curable material may be a liquid curable material, i.e. a liquefied version of the cured material. The curable material may cure to form the cured material.

Carrying out steps of providing the above-mentioned parts for manufacturing an inductive device may not be limited to being carried out in the above-mentioned order.

According to one aspect, the method comprises attaching the rigid terminal element (e.g., using the threaded hole or through hole thereof) to the lead wire while the winding being accommodated in the void. According to another aspect, the method comprising attaching the rigid terminal element to the lead wire prior to the winding being accommodated in the void. The winding may be accommodated in a coil former, which is accommodated into the magnetic core after the rigid terminal elements are attached to the winding via the lead wires.

According one aspect, the winding is deemed to be accommodated in the void when at least part of the winding is accommodated in at least a part of the magnetic core defining at least a part of the void. According to another aspect, the winding is deemed to be accommodated in the void when the entire winding is accommodated in the entire magnetic core defining the entire void.

Attaching the rigid terminal element to the lead wire may comprise cutting the lead wire at a desirable length, which may be carried out after forming the winding.

Prior to attaching the rigid terminal element to the lead wire, isolation (such as enamel) of the lead wire may be removed at least from the part of the lead wire to be attached. This may facilitate electrical connection between the lead wire and the rigid terminal element.

The rigid terminal element may be attached to the lead wire by providing a part of the lead wire within a void, such as a hole, such as a bore, defined by the rigid terminal element. This may be followed by a clamping action on an outer surface of the rigid terminal element. Accordingly, one or more inner surface parts, which at least partly define the void of the rigid terminal element accommodating the respective part of the lead wire, may be clamped towards the respective part of the lead wire. If the void of the rigid terminal element comprises one or more protrusions, such as being threaded, connection between the rigid terminal element and the lead wire may be facilitated. Furthermore, the clamping action on the outer surface of the rigid terminal element may form a clamped outer surface thereof, such as by forming an uneven surface having a plurality of protrusions.

The void opening may face upwards during provision of the curable material.

Provision of the curable material may comprise provision of the curable material to the void of the magnetic core, such that the winding being embedded in the curable material.

Provision of the curable material may comprise provision of the curable material within the opening of the magnetic core, such as by filling the opening.

### BRIEF DESCRIPTION OF THE DRAWINGS

The above, as well as additional objects, features and advantages of the present inventive concept, will be better understood through the following illustrative and non-limiting detailed description of preferred embodiments of the present inventive concept, with reference to the appended drawings, where like reference numerals will be used for like elements.

FIG. 1 is a perspective view schematically illustrating an embodiment of an inductor according to the present invention.

FIGS. 2A and 2B are perspective views schematically illustrating an example of an inductor core.

FIG. 3 is a top view schematically illustrating an inductor core of the inductor illustrated in FIG. 1.

FIGS. 4 and 5 schematically illustrate exploded views of the inductor illustrated in FIG. 1 without the cured material.

FIG. 6 schematically illustrates a perspective view of a section of the device of FIG. 1 without the cured material.

FIG. 7 schematically illustrates a perspective view of a section of the device of FIG. 1.

FIGS. 8 and 9 schematically illustrate the same cross sectional side view, but with different illustrative means, of the inductor of FIG. 1 seen perpendicular to the axial direction and intersecting the void opening.

FIG. 10 schematically illustrates a perspective view of a section of the device of FIG. 1 during manufacture thereof.

FIGS. 11A-11D schematically illustrate different perspective and cross-sectional side views of the rigid terminal element before and after being attached to the winding via the lead wire thereof.

FIGS. 12A-12D schematically illustrate different perspective and cross-sectional side views of an alternative rigid terminal element before and after being attached to the winding via the lead wire thereof.

### DETAILED DESCRIPTION

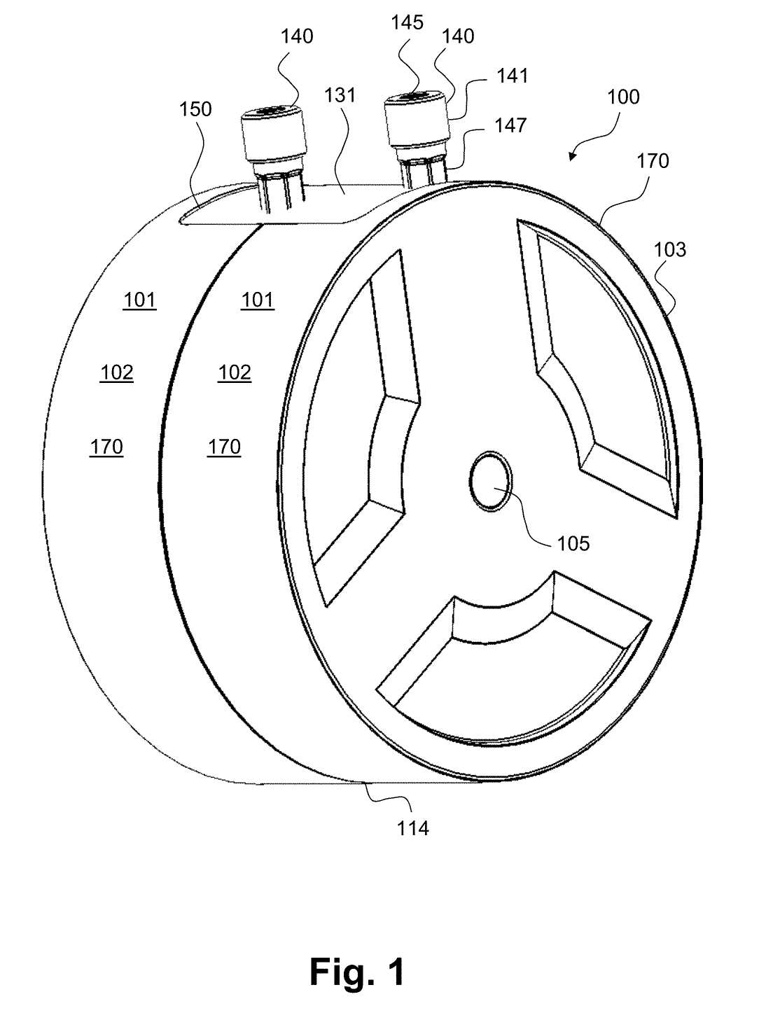

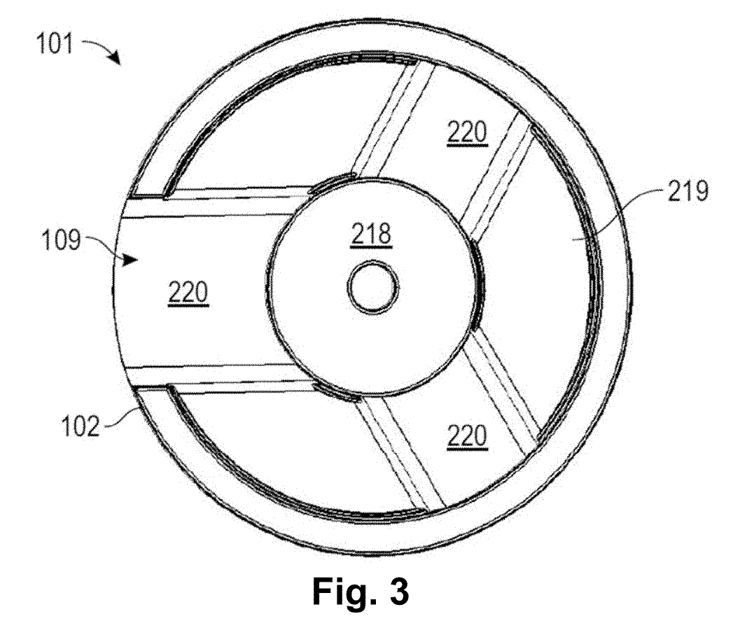

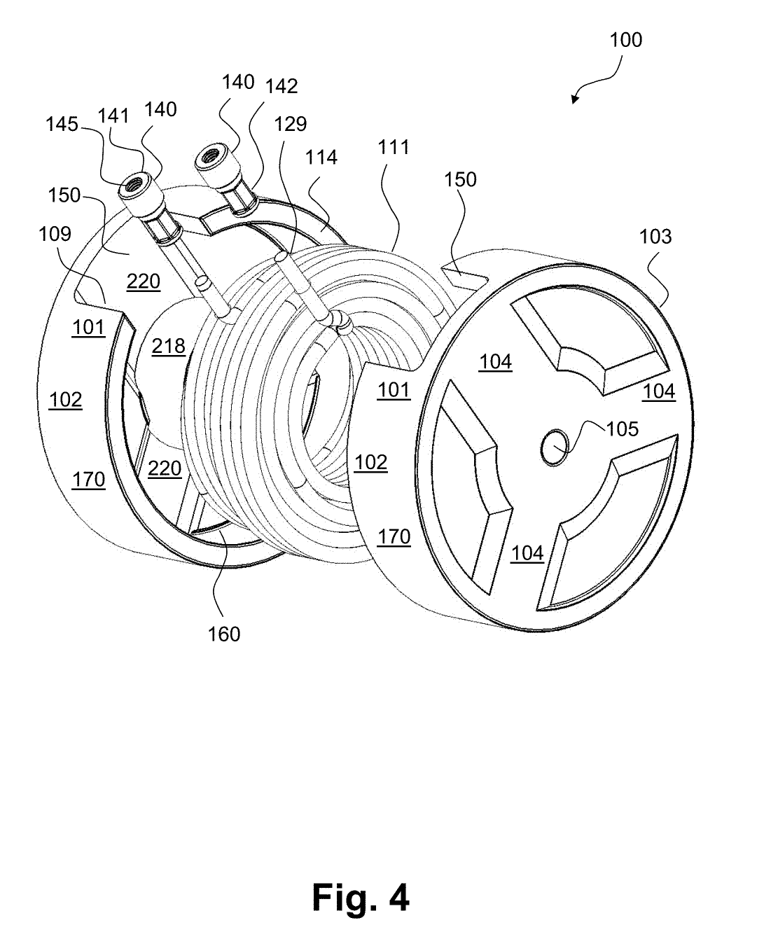

FIG. 1 schematically illustrate an assembled inductor (inductive device) 100 according to the present invention. With reference to FIG. 1 (as well as FIGS. 3-11) the inductive device 100 comprises: a magnetic core 170 forming a void 160 (see FIGS. 4-10) and a void opening 150; a winding 111 (see FIGS. 4-6 and 8-10) accommodated in the void 160 of the magnetic core 170; at least one lead wire 129 (comprising two lead wires 129) (see FIGS. 4-6 and 8-10) extending from the winding 111; a cured material 131 (see FIGS. 1 and 7-9) provided at least at a part of the void opening 150; and at least one rigid terminal element 140 (comprising two elements 140) connected to the winding 111 via the at least one lead wire 129, the at least one rigid terminal element being partly embedded in and protruding from the cured material 131. The winding 111 defines an axial direction.

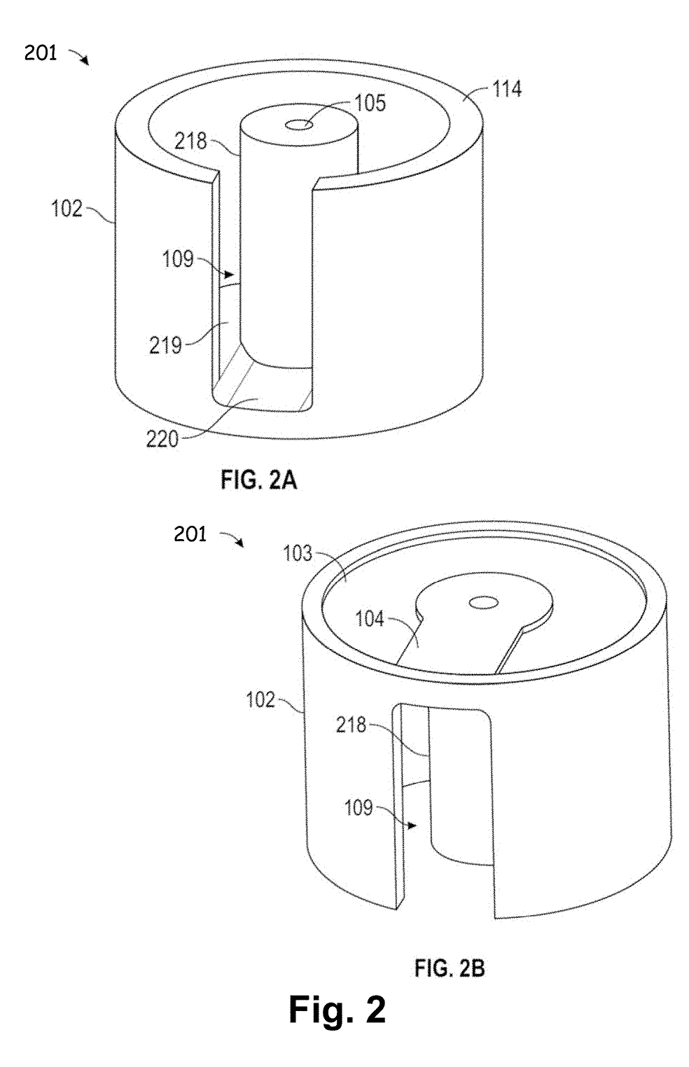

The magnetic core 170 is of the pot core type and is formed by two identical magnetic core components 101, examples of which are described further in connection with FIGS. 2A, 2B, and 3.

FIGS. 2A and 2B are perspective views illustrating an example of a magnetic core component 201 for an inductor, e.g., one or both of the magnetic core components 101 that form the magnetic core 170 of the inductor 100 of FIG. 1.

FIG. 3 is a top view illustration (i.e. a view into the open end of the magnetic core component) of one or both of the magnetic core components 101 of the inductor 100 of FIG. 1. The magnetic core component 101 is similar to the magnetic core component 201 of FIGS. 2A and 2B, but it differs in that it includes more than one recess 220.

Each component 101, 201 is formed as a pot-shaped component (or a half or a part thereof) comprising a base core portion 103, an inner core portion 218 and an outer core portion 102 forming a circumferential wall. Each magnetic core component 101, 201 thus has a closed end formed by the base portion 103 and an opposite open end delimited by a rim or end surface 114 of the outer core portion. The magnetic core components are assembled with the rims of their respective outer core portions facing each other. The end faces may abut each other or otherwise engage each other or be connected with each other.

The magnetic core component 101, 201 may be made of a compressed soft magnetic powder material and it comprises a disc-shaped base core portion 103. The base core portion 103 includes an inner surface 219 and an outer surface, opposite the inner surface. The inner core portion 218 extends perpendicularly from the inner surface 219 in the axial direction. The inner core portion 218 has an annular cross section. The outer core portion 102 is provided in the form of a tubular wall which extends in the axial direction from the inner surface 219 and whose opposite end defines the rim 114 of the outer core portion 102.

The inner core portion 218 extends from a center part of the base core portion 103 while the outer core portion 102 extends from a radially outermost periphery of the base core portion 103. When a magnetic core 170 is assembled from two magnetic core components 101, 201, the outer core portions 102 together form a circumferential housing (which defines the void 160) of the magnetic core 170. The magnetic core 170 thus provides a magnetic flux path axially along the inner core portion, radially inward/outward through the disc-shape base core portions and a return path axially along the outer core portion.

The inner core portion 218 may be provided with an axially extending hole 105. The hole may be a through-hole. The hole may be arranged to receive fastening means, such as a bolt or the like, for attaching the inductor core 170 to an outer structure.

The outer core portion 102 at least partly surrounds and is arranged coaxially with the inner core portion 218. Thereby, an annular void 160 extending radially and axially between the inner core portion 218 and the outer core portion 102 is formed. In this space, a winding 111 (as illustrated in FIGS. 4-6 and 8-10) may be accommodated.

The outer core portion 102 includes a slit 109. The slit 109 extends from the rim 114 towards the inner surface 219 of the base core portion 103. The slit 109 extends through the full radial thickness of the outer core portion 102. The wall portions of the outer core portion 102 defining the slit 109 extend along the axial direction. When assembled with another magnetic core component, the slit 109 defines at least part of the void opening 150.

The inner surface 219 includes a recess 220 extending in the radial direction from the inner core portion 218 towards the slit 109, thereby joining the slit 109, wherein the recess 220 forms the bottom of the slit 109. At the radial position where the recess 220 joins the slit 109, the recess 220 and the slit 109 have approximately equal widths, i.e. equal circumferential dimensions.

The recess 220 is arranged to accommodate one or more connecting leads (i.e. lead wire 129) of one or more windings arranged around the inner core portion 218. In particular, a lead wire 129 (see FIGS. 4-6 and 8-10) from the inner turn of the winding 111 (see FIGS. 4-6 and 8-10) may extend radially outwards in the recess 220 and through the slit 109. The slit 109 is arranged to provide a lead-through for a lead wire. Lead wires of one or more windings may thus be arranged through the slit 109 and along the recess 220 of the base core portion 103 towards the inner core portion 218 while occupying a minimum volume of the winding space.

The outer surface of the base core portion 103 comprises a protrusion 104. The protrusion 104 protrudes in the axial direction. The protrusion 104 extends in a radial direction from a central part of the outer surface towards an outer radial edge of the outer surface. The protrusion 104 is coextensive with the recess 220 by extending along, and in parallel with the recess 220.

The inner surface 219 of the base core portion of the magnetic core component 101 of FIG. 3 includes three recesses 220. The recesses are symmetrically distributed on the inner surface with respect to an angular direction such that an angle of approximately 120° is formed between adjacent pairs of recesses. However other distributions are also possible. The outer core portion 102 comprises a slit 109 which extends from the rim of the outer core portion towards one of the recesses 220 which recess thus forms the bottom of the slit 109.

It should be noted that a magnetic core component may include a different number of recesses than one or three as described above. For example, a magnetic core component may include two recesses and two corresponding protrusions. In that case, the two recesses (and the two protrusions) may be arranged at an angle of 180° in relation to each other.

In the magnetic core components described above, one of the recesses 220 extends from the inner core portion 218 to the slit 109. According to an alternative embodiment, the radially innermost part of the recess 220 may be separated from the inner core portion 218 by a distance, i.e. a non-zero distance. This may be useful, for example, when using a multi-layer winding having a thickness such that the outer layer of the winding roughly coincides with the innermost radial part of the recess 220 wherein the connection portion of the winding which is to be accommodated in the recess leaves the winding at the innermost radial part of the recess 220.

Going back to FIG. 1 as well as FIGS. 4-11, the rigid terminal elements 140 protrude from the void opening 150. Furthermore, the rigid terminal elements 140 are at least partly accommodated within the void opening 150. The void opening 150 is defined by the outer core portion 102.

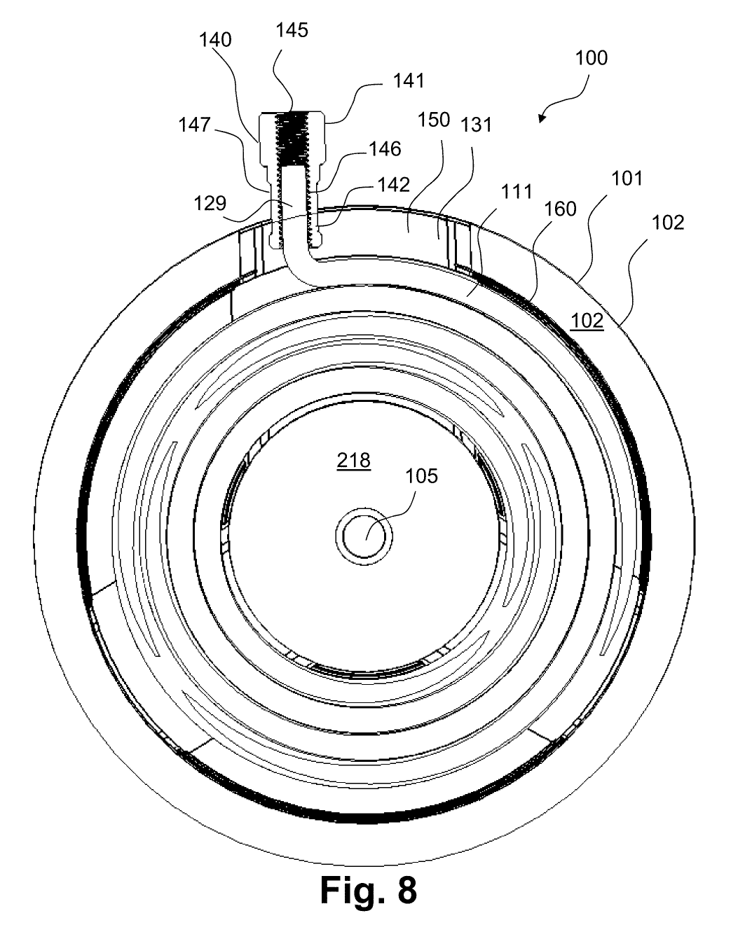

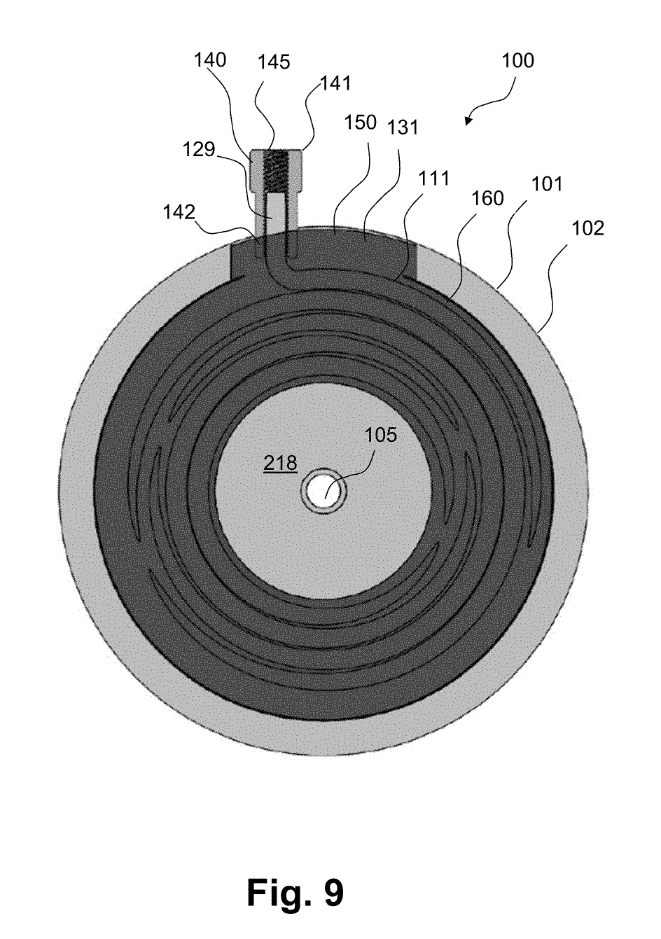

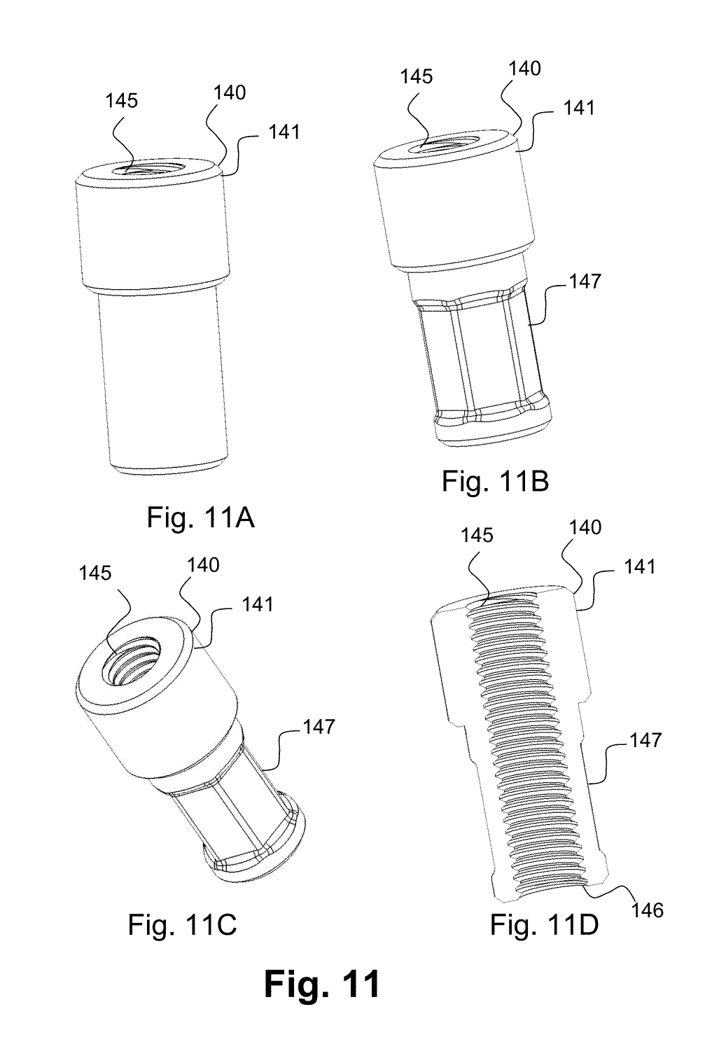

The rigid terminal elements 140 extend along a longitudinal direction. The rigid terminal elements 140 have a distal end 141 protruding from the cured material 131 and a proximal section 142 embedded in the cured material 131 (see in particular FIGS. 8 and 9). Different views of the rigid terminal alone are better seen in FIG. 11. An outer surface of a cross section of the proximal section, which cross section being perpendicular to the longitudinal direction, is non-circular. More particular, the cross section is substantially polygonal and has a plurality of protrusions.

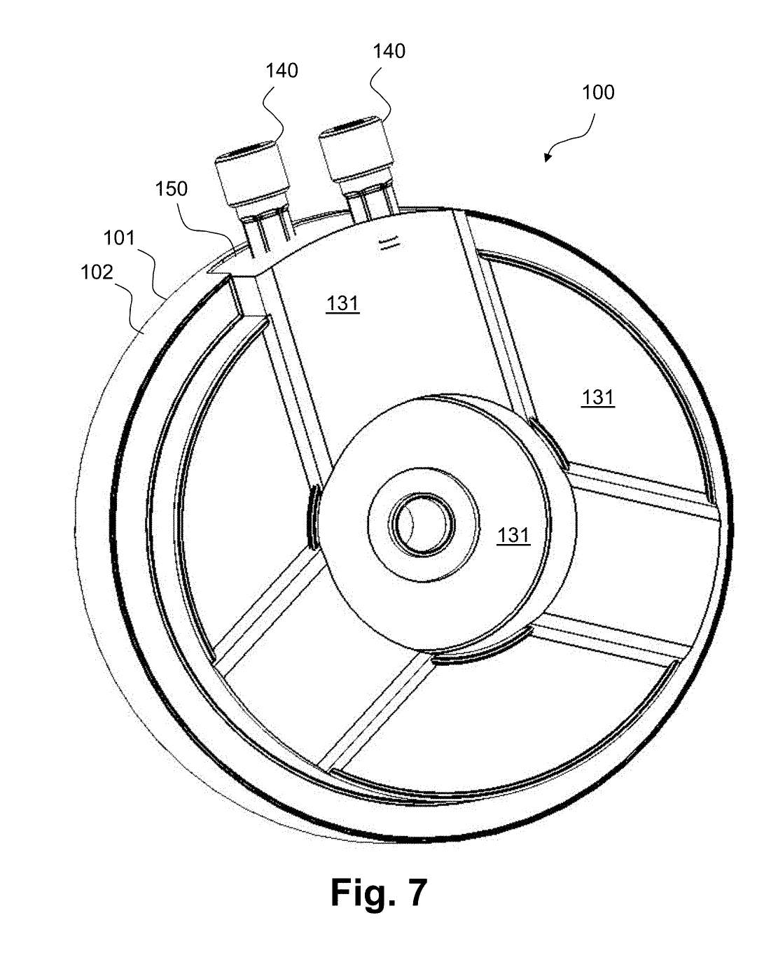

The cured material 131 is provided within at least a part of the void opening 150. As illustrated in FIGS. 1 and 7-9, the cured material 131 is provided within substantially the entire void opening 150. As illustrated in FIGS. 7-9, the cured material 131 is provided within substantially the entire void 160 not occupied by any other part, like the winding 111 and the lead wires 129. In FIG. 7, where one half of the magnetic core 170 is removed, it can be seen that the extent of the cured material 131 inside the void 160 is defined by the inner side of the magnetic core component 101, as described in connection with FIG. 3.

Each of the rigid terminal elements 140 comprise an external connection part 145 located at the distal end 141 of the rigid terminal element 140. The external connection part 145 is a threaded bore.

Each of the rigid terminal elements comprise an internal connection part 146 located opposite the distal end 141 of the rigid terminal element. The internal connection part is arranged for connection with the lead wire 129. The internal connection part 146 comprises a threaded hole in form of a bore. The threaded hole of the internal connection part 146 and the threaded hole of the external connection part 145 form a threaded through hole which extend along the longitudinal direction of the rigid terminal element.

The rigid terminal element 140 is attached to the lead wire 129 by providing a part of the lead wire within a hole (i.e., the internal connection part 146) defined by the rigid terminal element 140. This is followed by a clamping action on an outer surface 147 of the rigid terminal element. Accordingly, one or more inner surface parts, which at least partly define the hole of the rigid terminal element accommodating the respective part of the lead wire 129, is clamped towards the respective part of the lead wire. Since the hole 146 of the rigid terminal element 140 is threaded, connection between the rigid terminal element and the lead wire is facilitated. Furthermore, the clamping action on the outer surface 147 of the rigid terminal element has formed (or will form) a clamped outer surface thereof. Accordingly, an uneven surface 147 having a plurality of protrusions, and being substantial polygonal is formed.

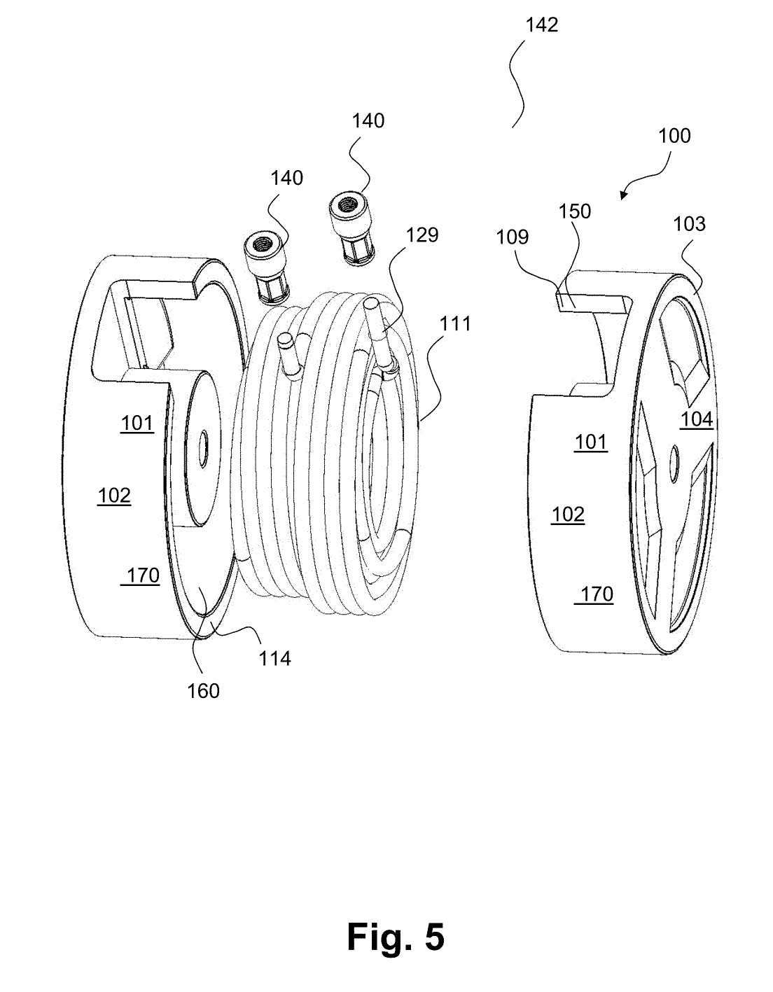

In FIGS. 4 and 5, the cured material has been left out for illustrative purposes.

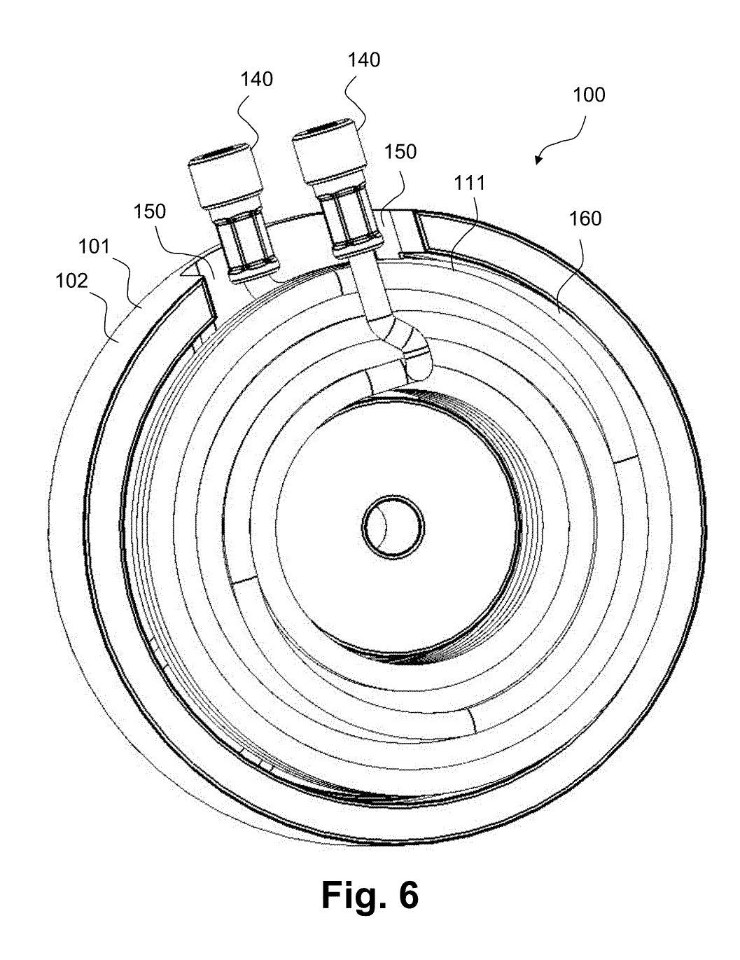

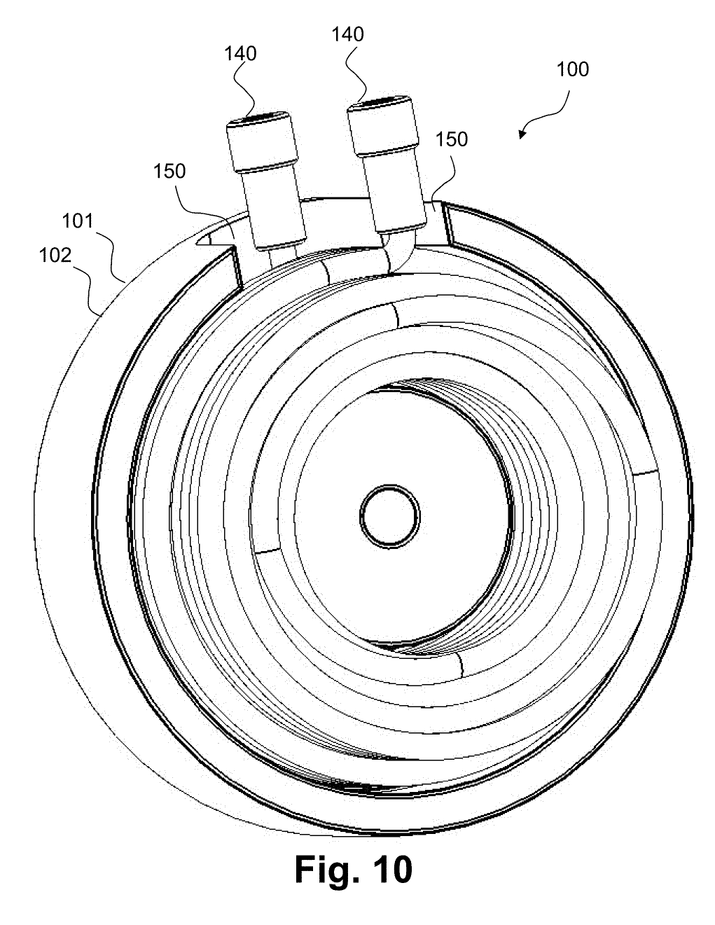

FIG. 10 illustrates a part of the inductive device 100, similar to what is illustrated in FIG. 6, but prior to the clamping action. In FIG. 10, the lead wires are accommodated in the internal connection part thereof.

FIGS. 11A-11D schematically illustrate four different views of the rigid terminal element 140. FIG. 11A shows the rigid terminal element 140 prior to being clamped. FIG. 11B shows a perspective view of the rigid terminal element 140 after being clamped. FIG. 11C shows another perspective view of the rigid terminal element 140 after being clamped. FIG. 11D shows a cross-sectional side view of the rigid terminal element 140 after being clamped, but without the lead wire.

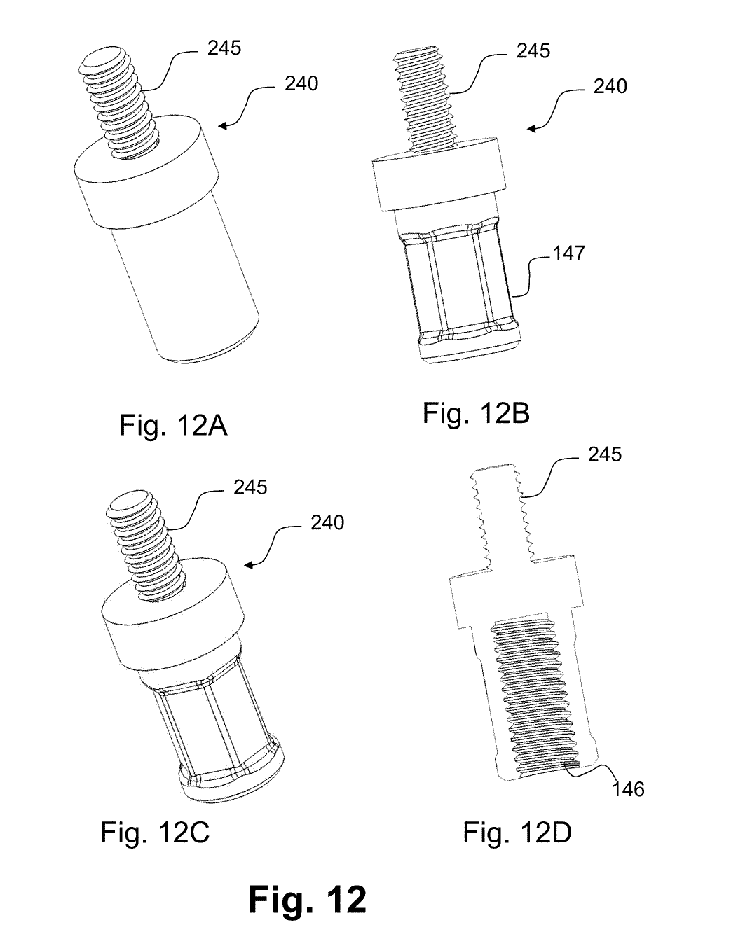

The rigid terminal element 240 illustrated in FIG. 12 is similar to the element 140 illustrated in FIG. 11. The only difference is that the external connection part 245 of FIG. 12 is provided as a threaded protrusion instead of a threaded bore 145 as illustrated in FIG. 11.

FIGS. 12A-12D schematically illustrate four different views of the rigid terminal element 240. FIG. 12A shows the rigid terminal element 240 prior to being clamped. FIG. 12B shows a perspective view of the rigid terminal element 240 after being clamped. FIG. 12C shows another perspective view of the rigid terminal element 240 after being clamped. FIG. 12D shows a cross-sectional side view of the rigid terminal element 240 after being clamped, but without the lead wire.

Although one or more embodiments have been described and shown in detail, the invention is not restricted to them, but may also be embodied in other ways within the scope of the subject matter defined in the following claims. In particular, it is to be understood that other embodiments may be utilized and structural and functional modifications may be made without departing from the scope of the present invention. For example, although an inductive device having circular cross sections has been described in the above, the inventive concept is not limited to this specific shape. For example, the magnetic core may present a section of a circular cross section, an elliptical cross section, a rectangular cross-section, a polygonal cross section etc. without departing from scope of the present inventive concept, as defined in the independent claims.

In device claims enumerating several features, several of these features can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in the present disclosure is taken to specify the presence of stated features, integers, steps or components but does not preclude the presence or addition of one or more other features, integers, steps, components or groups thereof.

1. An inductive device comprising:
a magnetic core forming a void and a void opening;
a winding accommodated in the void of the magnetic core;
at least one lead wire extending from the winding;
a cured material provided at least at a part of the void opening; and
at least one rigid terminal element connected to the winding via the at least one lead wire, the at least one rigid terminal element being partly embedded in and protruding from the cured material.

2. The inductive device according to claim 1, wherein the rigid terminal element protruding from the void opening.

3. The inductive device according to claim 1, wherein the rigid terminal element being at least partly accommodated within the void opening.

4. The inductive device according to claim 1, wherein the rigid terminal element extending along a longitudinal direction, the rigid terminal element having a distal end protruding from the cured material and a proximal section embedded in the cured material, wherein an outer surface of a cross section of the proximal section, which cross section being perpendicular to the longitudinal direction, being non-circular.

5. The inductive device according to claim 4, wherein the outer surface having one or more protrusions.

6. The inductive device according to claim 1, wherein the rigid terminal element comprising a metal alloy.

7. The inductive device according to claim 1, wherein the rigid terminal element comprising an external connection part configured to enable electrical connection.

8. The inductive device according to claim 1, wherein the cured material comprising cured epoxy.

9. The inductive device according to claim 1, wherein the cured material being provided within at least a part of the void opening.

10. The inductive device according to claim 1, wherein the cured material being provided within the void of the magnetic core.

11. A method for manufacturing an inductive device, the method comprising:
providing a magnetic core forming a void and a void opening;
providing a winding in the void of the magnetic core;
providing at least one lead wire extending from the winding;
providing at least one rigid terminal element connected to the winding via the at least one lead wire; and
providing a curable material at least at a part of the void opening, such that the at least one rigid terminal element being partly embedded in and protruding from the curable material.

12. The method according to claim 11, comprising attaching the rigid terminal element to the lead wire while the winding being accommodated in the void.

13. The method according to claim 12, wherein attaching the rigid terminal element to the lead wire comprises cutting the lead wire at a desirable length.

14. The method according to claim 11, wherein the void opening is facing upwards during provision of the curable material.

15. method according to claim 11, wherein provision of the curable material comprises provision of the curable material to the void of the magnetic core, such that the winding being embedded in the curable material.
